(19) United States
(12) Patent Application Publication
(10) Pub. No.: US 2020/0009536 A1
(43) Pub. Date: Jan. 9, 2020

(54) MANUFACTURING METHODS FOR SUPPORTED CATALYSTS AND CARBON NANOSTRUCTURES

(71) Applicants: WASEDA UNIVERSITY, Shinjuku-ku Tokyo (JP); ZEON CORPORATION, Chiyoda-ku Tokyo (JP)

(72) Inventors: Suguru NODA, Shinjuku-ku, Tokyo (JP); Risa MAEDA, Shinjuku-ku, Tokyo (JP); Akiyoshi SHIBUYA, Chiyoda-ku, Tokyo (JP); Takayoshi HONGO, Chiyoda-ku, Tokyo (JP)

(73) Assignees: WASEDA UNIVERSITY, Shinjuku-ku Tokyo (JP); ZEON CORPORATION, Chiyoda-ku Tokyo (JP)

(21) Appl. No.: 16/483,843

(22) PCT Filed: Feb. 16, 2018
(86) PCT No.: PCT/JP2018/005587

§ 371 Date: Aug. 6, 2019

(30) Foreign Application Priority Data
Feb. 17, 2017 (JP) 2017-028205

(51) Int. Cl. B01J 23/745; B01J 37/02; B01J 37/18; C01B 32/162

(52) U.S. Cl. CPC B01J 23/745; B01J 37/02; B82Y 40/00; C01B 32/162; B01J 37/18

(57) ABSTRACT

A manufacturing method for supported catalysts comprising a step A of forming a mixed layer having a catalyst component and a catalyst carrier component on at least a portion of the surface of a support body having a catalytic layer by bringing a mixed solution comprising a catalyst raw material and a catalyst carrier raw material into contact with the support body having a catalytic layer on the surface. Furthermore, such a manufacturing method for supported catalysts preferably comprises a step B in which the catalyst component is made to segregate to a surface of the mixed layer after step A.

### TECHNICAL FIELD

The present disclosure relates to a manufacturing method for a supported catalysts and carbon nanostructures.

### BACKGROUND

In recent years, carbon nanostructures such as carbon nanotubes (hereinafter, referred to as “CNTs”) constructed from carbon atoms have been attracting attention as materials having various excellent characteristics such as electrical conductivity, thermal conductivity, and mechanical characteristics.

Moreover, a method for using a supported catalyst having a support body and a catalyst component supported on the support body to produce a carbon nanostructure having desired properties and characteristics on the catalyst component is known as a method for manufacturing a carbon nanostructure. Further, when the supported catalyst is used to produce a carbon nanostructure, normally, a catalyst carrier component is furthermore provided between the support body and the catalyst component in order to better support the catalyst component on the support body.

Here, in the conventional method which uses the supported catalyst in which the catalyst component is supported on the support body to manufacture the carbon nanostructure, generally, the cost of the support body itself is a large proportion of the entire manufacturing cost. Therefore, the efficient use of the support body is necessary in order to reduce the manufacturing cost of a carbon nanostructure.

For example, PTL1 discloses a technique for reusing a substrate for producing CNTs by repeatedly providing a base layer (catalyst carrier component) and a catalytic layer on a substrate for producing CNTs once used for the manufacture of the CNTs. Specifically, in PTL1, a structure obtained by sputtering a silicon oxide film (thickness: 100 nm)/alumina base film (thickness: 10 nm)/Fe catalyst membrane (thickness: 1 nm) on one surface of the support body consisting of a plate-like Fe-Ni-Cr alloy was used as the substrate for producing CNTs. Moreover, in PTL1, the substrate for producing CNTs is reused multiple times by scraping the CNTs produced and grown on the aforementioned substrate for producing CNTs by Chemical Vapor Deposition (CVD) method from the substrate with a spatula, removing carbon impurities formed on the catalyst component surface of the substrate by an oxygen plasma treatment to initialize the substrate, and furthermore, forming the base membrane/catalyst membrane on the initialized substrate in the same manner described above.

Therefore, in PTL1 which reuses the substrate for producing CNTs multiple times, CNTs of the same quality are obtained regardless of the number of reuses.

### CITATION LIST

### Patent Literature

PTL 1: JP5574257B

### SUMMARY

(Technical Problem)

However, in the dry process described in PTL1, the equipment was large-scale and vacuum control was required. Therefore, a method by which a catalyst component can be repeatedly and easily supported on the support body has been sought.

On the one hand, a wet process such as a sol-gel method, a solution immersion method, or a metal organic compound decomposition method can be used as a method for easily supporting the catalyst component. However, we performed examinations, and considered that, for example, when a wet process was used to form a catalyst carrier component on a support body, and furthermore, support the catalyst component, the denseness of the base layer was often insufficient, and the catalyst component once used in the synthesis of CNTs and the like can reduce the catalytic performance of the newly formed catalyst component. Therefore, there was room for further improvements in the points of exhibiting a high catalytic performance in the catalyst component and repeatedly manufacturing high-quality carbon nanostructures even when the catalyst component is repeatedly supported on the support body by a wet process.

An object of the present disclosure is to provide a manufacturing method for a supported catalyst which can manufacture a supported catalyst which can efficiently and repeatedly prepare high-quality carbon nanostructures.

Further, an object of the present disclosure is to provide a method of manufacturing a carbon nanostructure efficiently and repeatedly manufacturing high-quality carbon nanostructures.

(Solution to Problem)

The inventors made extensive studies to solve the aforementioned problems. The inventors discovered that it was difficult to form the catalyst component and the catalyst carrier component with a compact and uniform film thickness when repeatedly supporting a catalyst component on a support by a wet process. Further, the inventors focused on the fear that when repeatedly supporting the catalyst component on the support body, while supporting the catalyst component (current catalyst component) on the outermost surface, already supported catalyst component (pre-catalyst component) moves and diffuses to the upper part of the catalyst carrier component present between the pre-catalyst component and the current catalyst component to degrade the catalytic performance of the current catalyst component.

Moreover, the inventors, furthermore, performed keen research, and discovered that if the mixed solution comprising the catalyst raw material and the catalyst carrier raw material is made to contact with the support body having the layer (catalytic layer)containing the pre-catalyst component which is already supported on the surface to form the mixed layer having the catalyst component and the catalyst carrier component, the supported catalyst excellent in the catalytic performance can be efficiently obtained. Further, the inventors discovered that if using the supported catalyst in which the aforementioned predetermined mixed layer is formed, high-quality carbon nanostructures can be efficiently and repeatedly prepared, and completed the present disclosure.

Namely, it is an object of the present disclosure to solve the aforementioned problems, and the manufacturing method for the supported catalysts of the present disclosure comprises a step A of forming a mixed layer having a catalyst component and a catalyst carrier component on at least a portion of the surface of a support body having a catalytic layer by bringing a mixed solution comprising a catalyst raw material and a catalyst carrier raw material into contact with the support body having a catalytic layer on the surface. Therefore, if the predetermined mixed solution is brought into contact with the support body having the catalytic layer on the surface, the supported catalyst in which the predetermined mixed layer which exhibits a high catalytic performance was formed can be obtained. Moreover, if the supported catalyst is used, high-quality carbon nanostructures can be repeatedly and efficiently manufactured.

Here, the manufacturing method for the supported catalyst of the present disclosure preferably further comprises a step B in which the catalyst component is made to segregate to a surface portion of the mixed layer after the step A. If the catalyst component segregates to the surface portion of the mixed layer in the supported catalyst, the catalytic performance of the supported catalyst having the mixed layer formed further increases, and higher quality carbon nanostructures can be repeatedly and efficiently manufactured.

Further, in the manufacturing method for the supported catalyst of the present disclosure, a reducing agent is preferably provided to the mixed layer in the step B. If the reducing agent is provided to the mixed layer, the catalyst component can be more sufficiently segregated to the surface portion of the mixed layer. Therefore, the catalytic performance of the supported catalyst having the mixed layer formed further increases, and a higher quality carbon nanostructure can be repeatedly and efficiently manufactured.

Further, in the manufacturing method for the supported catalyst of the present disclosure, an absolute value of the difference between a supersaturation ratio of the catalyst raw material and a supersaturation ratio of the catalyst carrier raw material in the mixed solution is preferably 0.5 or less. If the difference between the supersaturation ratio of the catalyst raw material and the supersaturation ratio of the catalyst carrier raw material in the mixed solution is the aforementioned upper limit or less, for example, the timing of the precipitation of the catalyst raw material and the catalyst carrier raw material during the drying of the mixed solution can be made close to make the ratio between the catalyst component and the catalyst carrier component uniform. Therefore, it is possible to form a mixed layer which is uniform in composition and has an excellent catalytic performance, and higher quality carbon nanostructures can be repeatedly and efficiently manufactured.

Note that, in the present disclosure, the “supersaturation ratio” is a value obtained by the actual concentration to the solubility of certain solutes in solution (supersaturation ratio=concentration/solubility, and is unitless) at a temperature under 25° C., and the solution having a supersaturation ratio of 1.0 indicates to be in a saturated state.

Further, in the manufacturing method for the supported catalyst of the present disclosure, the supersaturation ratio of the catalyst raw material and/or the supersaturation ratio of the catalyst carrier raw material in the mixed solution is preferably from 0.3 to 1.0. In the mixed solution in which the absolute value of the difference of the supersaturation ratios of the catalyst raw material and the catalyst carrier raw material is 0.5 or less, if the supersaturation ratios of the catalyst raw material and/or the catalyst carrier raw material are within the aforementioned predetermined range, when, for example, the mixed solution is applied in contact and dried to form a mixed layer, the catalyst component and/or the catalyst carrier component is more uniformly precipitated. Further, if the supersaturation ratio of the catalyst raw material and/or the catalyst carrier raw material is within the aforementioned predetermined range, for example, the catalyst component and/or the catalyst carrier component is more uniformly precipitated on the support body in a short time from the start of drying of the mixed solution, and the mixed layer can be formed more uniformly. Therefore, the catalytic performance of the mixed layer further increases, and further high-quality carbon nanostructures can be efficiently and repeatedly prepared.

Further, in the manufacturing method for the supported catalyst of the present disclosure, the support body is preferably ceramic particles. If the support body is ceramic particles, high-quality carbon nanostructures can be further efficiently and repeatedly prepared in the manufacturing step of the carbon nanostructures.

Further, in the manufacturing method for the supported catalyst of the present disclosure, an apparent density of the ceramic particles is preferably 2.0 g/cm³ or more. If the apparent density of the ceramic particles is the aforementioned lower limit or more, high-quality carbon nanostructures can be more efficiently manufactured repeatedly.

Note that, in the present disclosure, the “apparent density” was measured as prescribed in JIS R 1620.

Moreover, in the manufacturing method for the supported catalyst of the present disclosure, the catalyst raw material preferably comprises at least one element selected from the group consisting of Fe, Co and Ni. If the composition of the catalyst raw material is as stated above, the catalytic performance of the mixed layer can be further increased, and even higher quality carbon nanostructures can be repeatedly and efficiently manufactured.

Further, an object of the present disclosure is to advantageously solve the aforementioned problems, and the method of manufacturing the carbon nanostructures of the present disclosure comprises step C which uses the supported catalyst obtained by any of the aforementioned manufacturing methods to synthesize the carbon nanostructures. Therefore, if the supported catalyst obtained by any of the aforementioned manufacturing methods is used, high-quality carbon nanostructure can be efficiently obtained repeatedly.

Here, in the method of manufacturing the carbon nanostructures of the present disclosure, the carbon nanostructures are preferably carbon nanotubes (CNTs). If the supported catalyst obtained by any of the aforementioned manufacturing methods is used to synthesize the CNTs, high-quality CNTs can be efficiently obtained repeatedly.

(Advantageous Effect)

According to the present disclosure, a manufacturing method for a supported catalyst which can manufacture a supported catalyst which can efficiently and repeatedly prepare high-quality carbon nanostructures can be obtained.

Further, according to the present disclosure, a method of manufacturing the carbon nanostructures efficiently and repeatedly manufacturing high-quality carbon nanostructures can be obtained.

### BRIEF DESCRIPTION OF THE DRAWINGS

In the accompanying drawings:

FIG. 1A is a scanning electron microscope (SEM) image of the supported catalyst after performing the synthesis treatment of CNTs according to Example 1;

FIG. 1B is an SEM image of the supported catalyst after performing the synthesis treatment of CNTs according to Example 2;

FIG. 1C is an SEM image of the supported catalyst after performing the synthesis treatment of CNTs according to Example 3;

FIG. 1D is an SEM image of the supported catalyst after performing the synthesis treatment of CNTs according to Comparative Example 1;

FIG. 1E is an SEM image of the supported catalyst after performing the synthesis treatment of CNTs according Comparative Example 2;

FIG. 1F is an SEM image of the supported catalyst after performing the synthesis treatment of CNTs according to Comparative Example 3;

FIG. 1G is an SEM image of the supported catalyst after performing the synthesis treatment of CNTs according to Comparative Example 4;

FIG. 1H is an SEM image of the supported catalyst after performing the synthesis treatment of CNTs according to Comparative Example 5;

FIG. 1I is an SEM image of the supported catalyst after performing the synthesis treatment of CNTs according to a first round of Comparative Example 6;

FIG. 1J is an SEM image of the supported catalyst after performing the synthesis treatment of CNTs according to a second round of Comparative Example 6;

FIG. 2A is an SEM image of the supported catalyst after performing the synthesis treatment of CNTs according to Example 4-1;

FIG. 2B is an SEM image of the supported catalyst after performing the synthesis treatment of CNTs according to Example 4-2; and

FIG. 3 is an SEM image of the supported catalyst after performing the synthesis treatment of CNTs according to Comparative Example 7.

### DETAILED DESCRIPTION

Embodiments of the present disclosure will be described in detail below.

Here, the manufacturing method for the supported catalyst of the present disclosure can be used to obtain the supported catalyst which can efficiently and repeatedly prepare the high-quality carbon nanostructures. More specifically, the manufacturing method for the supported catalyst of the present disclosure can be suitably used in order to obtain the supported catalyst which can efficiently and repeatedly prepare the high-quality carbon nanostructures using, for example, a so-called “spent supported catalyst” in an aspect in which the carbon nanostructures has been once synthesized and peeled.

Therefore, the manufacturing method for the supported catalyst of the present disclosure can be particularly preferably used to efficiently and repeatedly obtain the supported catalyst having a high catalytic performance while recycling the generally expensive support body contained in the “spent supported catalyst” to reduce the cost. Similarly, the method of manufacturing the carbon nanostructures of the present disclosure can be particularly preferably used to efficiently and repeatedly obtain the high-quality carbon nanostructures while recycling the generally expensive support body contained in the “spent supported catalyst” to reduce the cost.

Note that, the supported catalyst obtained by the manufacturing method of the present disclosure can be used adequately with, for example, various reactors which can be generally used in the synthesis of the carbon nanostructures such as a fluidized bed, a fixed bed, a transport bed, or a rotary furnace.

(Manufacturing method for supported catalyst)

It is necessary that the manufacturing method for the supported catalyst of the present disclosure includes step A for forming the predetermined mixed layer having the catalyst component and the catalyst carrier component by bringing the predetermined mixed solution into contact with the support body having the catalytic layer on the surface. Further, the manufacturing method for the supported catalyst of the present disclosure may further comprise, optionally, step A1 for preparing the support body having the catalytic layer on the surface and step A2 for preparing the mixed solution comprising the catalyst raw material and the catalyst carrier raw material prior to the aforementioned step A. Further, the manufacturing method for the supported catalyst of the present disclosure may further comprise, optionally, the aforementioned step B in which the catalyst component is made to segregate to the surface of the mixed layer after step A. Thereamong, from the viewpoint of further increasing the catalytic performance of the supported catalyst, the manufacturing method for the supported catalyst of the present disclosure preferably further comprises at least the aforementioned step B in addition to step A.

<Step A1>

In step Al which can be arbitrarily performed prior to step A, the support body having the catalytic layer on the surface is prepared. Here, a commercially available support body may be used, or, for example, a support body produced by the method described below may be used as the support body having the catalytic layer on the surface. The support body having the catalytic layer on the surface obtained in step A1 can be used in step A which is described later.

«Support body»

The support body is not specifically limited, and a known support body which may have the catalytic layer on the surface can be used.

Here, examples of the shape of the support body include a powder (normally less than 50 μm in volume average particle diameter); a particulate such as beads (usually 50 μm or more in volume average particle diameter); a honeycomb; a porous shape; a fibrous shape such as a fiber, tubular, or wire; a net-like shape such as a mesh or a lattice; sponge-like; plate-like; and film-like. For example, when using a fluidized bed reactor in step A, the support body is preferably a powder or a particulate from the viewpoints of the flowability and the reaction efficiency due to the large specific surface area, and furthermore, is more preferably a particulate from the viewpoint of the handling. Further, when using a fixed bed reactor in step A, the support body is preferably net-like, plate-like, or film-like from the viewpoint of the fixability, and furthermore, is more preferably plate-like from viewpoints such as the reaction efficiency due to the large reaction area and the handling.

Further, the material of the support body is not specifically limited, a ceramic material such as glass; quartz; oxides such as alumina (Al₂O₃), SiO₂, ZrO₂, ZnO; mullite (xM₂O.yAl₂O₃.zSiO₂.nH₂O {M is a metal atom, x to z, and n represent the molar number of each component (0 or more)}), an aluminosilicate such as zeolite; a carbide such as SiC; a nitride such as Si₃N₄,

a metallic material such as single elements such as Fe, Ni, Cr, Mo, W, Ti, Al, Mn, Co, Cu, Ag, Au, Pt, Nb, Ta, Pb, Zn, Ga, Ge, As, In, Sb; and alloys such as Fe—Cr, Fe—Ni, and Fe—Ni—Cr, and

a non-metallic material such as Si, P, mica, graphite, and diamond may be provided.

More specifically, when using a fluidized bed reactor, ceramic particles can be suitably used as the support body. If the support body is ceramic particles, for example, the support body and the supported catalyst can be filled three-dimensionally in a device during the wet process to further increase the manufacturing efficiency of the supported catalyst and the carbon nanostructures while suppressing the reaction between the support body and the catalyst component or the catalyst carrier component to effectively extract the catalytic performance of the supported catalyst. Further, if the support body is the ceramic particles, the support body and the supported catalyst easily flow adequately into the fluidized bed reactor without damage, thus, the supported catalyst and the high-quality carbon nanostructures can be efficiently and repeatedly prepared. Further, when using a fixed bed reactor, for example, a metallic plate such as a Fe—Ni—Cr alloy plate can be suitably used as the support body.

Note that, in the present disclosure, the aspect ratio (long diameter/short diameter) of the “particle” is normally 1 to less than 10, preferably 1 to less than 5. Further, in the present disclosure, the “aspect ratio” could be obtained by, for example, measuring the maximum diameter (long diameter) and the particle diameter (short diameter) of the direction orthogonal to the maximum diameter for any 50 particles measured by a scanning electron microscope (SEM), and calculating the average value of the ratio (long diameter/short diameter) of the long diameter and the short diameter.

[Ceramic particles]

—Apparent density—

Here, the ceramic particles as the support body preferably have an apparent density of 2.0 g/cm³ or more. If the apparent density of the ceramic particles is the aforementioned lower limit or more, i.e., the degree of porosity is low, the fluidity of the support body becomes better when, for example, the supported catalyst is manufactured by the fluidized bed method. Moreover, the mixed layer can be formed more efficiently, and the manufacturing efficiency of the supported catalyst further increase. Note that, the apparent density of the ceramic particles can be, for example, 7.0 g/cm³ or less.

—Particle diameter—

Further, the ceramic particles as the support body preferably have a volume average particle diameter of 2000 μm or less, more preferably 1000 μm or less, even more preferably 500 μm or less, and normally, is 50 μm or more, and preferably 80 μm or more. If the particle diameter of the ceramic particles is the aforementioned upper limit or less, a sufficiently large outer surface area can be maintained. Furthermore, if the particle diameter of the ceramic particles is 500 μm or less, when, for example, the supported catalyst is manufactured by the fluidized bed method, the support body can fluidize adequately without sinking or staying downward in the reactor. On the one hand, if the particle diameter of the ceramic particles is the aforementioned lower limit or more, the support body can, for example, be maintained in the reactor without the support body flowing out even if a reaction gas is flowing. As a result, the mixed layer having an excellent catalytic performance can be more efficiently formed, and high-quality carbon nanostructures can be efficiently and repeatedly manufactured. In addition, if the particle diameter of the ceramic particles is the aforementioned upper limit or less, generally, the cost of the support body itself can be further reduced.

Note that, in the present disclosure, the “volume average particle diameter” represents the particle diameter (D50) at which, in a particle size distribution (volume basis) measured by laser diffraction in accordance with JIS Z8825, the cumulative volume calculated from the small diameter end of the distribution reaches 50%.

«Catalytic layer»

The catalytic layer which the support body has on the surface thereof may be a layer in which any catalytic layer was formed alone on the surface of the support body; may be a laminate in which any catalytic layer was formed on any catalyst carrier layer on the surface of the support body, or a repeat of the laminate; and may be a layer in which a mixed layer having any catalyst component and any catalyst carrier component was formed on the surface of the support body. Further, the catalytic layer, the catalyst carrier layer, and the mixed layer may respectively be a single layer, or may be a multilayer consisting of a plurality of layers.

Further, the catalytic layer may also be (I) formed as is on the surface of the support body (unused supported catalyst); and may be (II) used, for example, in the manufacturing of the carbon nanostructures after being formed on the surface of the support body, and, after the manufactured carbon nanostructures were peeled (spent supported catalyst).

Moreover, the aforementioned “spent supported catalyst” includes the state of a spent supported catalyst after the manufacture and peeling of the aforementioned carbon nanostructures has been performed two or more times. More specifically, the aforementioned “spent supported catalyst” also includes the state after the manufacture and peeling of the aforementioned carbon nanostructures has been performed two or more times in succession, and also includes the state after the manufacture and the peeling of the aforementioned carbon nanostructures has been performed two or more times through the formation of any additional catalytic layer.

Thereamong, from the viewpoint of efficiently and repeatedly obtaining the high-quality carbon nanostructures while recycling the generally expensive support body to reduce the cost, the effects of the manufacturing method for the supported catalyst of the present disclosure are more exhibited when the catalytic layer is in the state of (II) a spent supported catalyst.

Moreover, when the catalytic layer is in the state of (II) a spent supported catalyst, in step A1, carbon impurities such as residues of the carbon nanostructures or a carbon coating produced during synthesis of the carbon nanostructures which may be present on the surface of the spent supported catalyst are preferably removed.

The case when the catalytic layer is in the state of the aforementioned (II) spent supported catalyst used in the synthesis of the carbon nanostructures will be described below as an example, but the present disclosure is not limited thereto.

Further, hereinafter, for the sake of convenience, the catalytic layer prior to being used in the synthesis of the carbon nanostructures will be referred to as the “unused catalytic layer”; the catalytic layer in a state in which the carbon nanostructures were synthesized will be referred to as the “synthesized catalytic layer”; the catalytic layer in a state in which the synthesized carbon nanostructures were peeled will be referred to as the “spent catalytic layer”; and the catalytic layer after further removing the carbon impurities remaining on the surface will be referred to as the “carbon removed catalytic layer”.

[Pre-catalyst component]

The composition (in some cases referred to as the “pre-catalyst component”) which may constitute the catalytic layer is not specifically limited, and examples of the composition include the same compositions as the catalyst component which is described later in the “mixed layer” item.

Here, according to our assumption, the pre-catalyst components such as Fe, Co, and Ni easily move and diffuse to the surface of the mixed layer in the formation of the mixed layer which is described later. Moreover, there is the fear that the pre-catalyst components which moved and diffused to the surface of the mixed layer will be added to the catalyst component (current catalyst component) of the mixed layer to reduce the catalytic performance of the current catalyst component. However, in the manufacturing method for the supported catalyst of the present disclosure, the predetermined mixed layer is formed on the catalytic layer, preferably, at least at the lower limit value of the suitable thickness which is described later, and thus, can suppress the pre-catalyst component from moving and diffusing to the surface of the mixed layer during the formation of the mixed layer, and can make current catalyst component exhibit an excellent catalytic performance.

[Pre-catalyst carrier component]

The composition (in some cases referred to as the “pre-catalyst carrier component”) which may configure the catalytic layer is not specifically limited, and examples of the composition include the same compositions as the catalyst carrier component which is described later in the “Mixed layer” item.

[Formation method of the unused catalytic layer]

The formation method of the unused catalytic layer on the surface of the support body may conform to a general layer formation method such as a dry method or a wet method.

«Synthesis of carbon nanostructures»

Further, the synthesis method of the carbon nanostructures on the unused catalytic layer may conform to, for example, the synthesis method, etc., which is described later in the step C item of “the method of manufacturing the carbon nanostructures”.

The support body has the synthesized catalytic layer on the surface thereby.

«Peeling of the carbon nanostructures»

The peeling of the carbon nanostructures from the synthesized catalytic layer is not specifically limited, for example, the entirety of the support body having the synthesized catalytic layer may be immersed in any solution, stirred by sonication and the like in accordance with need, and peeled by dispersing the carbon nanostructures in a solution. Further, the carbon nanostructures may be scrapped from the synthesized catalytic layer with a spatula, a cutter, and the like. Furthermore, for example, the entirety of the support body having the synthesized catalytic layer on the surface is vibrated, or, the entirety of the support body having the synthesized catalytic layer on the surface is arranged in an airflow to shake off the carbon nanostructures from the synthesized catalytic layer.

The support body has the spent catalytic layer on the surface, and may constitute the aforementioned “spent supported catalyst” thereby.

«Removal method of the carbon impurities»

The removal method of the carbon impurities which may be present on the spent catalytic layer obtained as stated above is not specifically limited, and, for example, a heat treatment may be performed while flowing air, or a plasma treatment may be performed.

The support body has a carbon removed catalytic layer on the surface, and may constitute the aforementioned “spent supported catalyst” thereby.

<Step A2>

In step A2 which may be optionally performed prior to step A, the mixed solution comprising the catalyst raw material and the catalyst carrier raw material is prepared. Here, a commercially available mixed solution comprising a catalyst raw material and a catalyst carrier raw material may be used, and for example, a mixed solution produced by the method described below may be used. Further, the mixed solution can furthermore comprise other additives, in addition to the aforementioned catalyst raw material and the catalyst carrier raw material. Moreover, the mixed solution obtained in step A2 can be used in step A which is described later.

«Catalyst raw material»

The catalyst raw material is a raw material that constitutes the catalyst component which plays a role in the mediation, promotion, and improvement in the efficiency of the synthesis of the carbon nanostructures. Moreover, the catalyst raw material preferably comprises at least one element selected from the group consisting of Fe, Co and Ni, and more preferably comprises at least Fe. Examples of the catalyst raw material include acetates, nitrates, oxalates, complexes, chlorides and the like of the aforementioned elements.

Specific examples of the catalyst raw material which can be suitable used include Fe-containing catalyst raw materials such as iron (II) acetate (Fe (CH₃COO)₂), iron (III) nitrate (Fe (NO₃)₃), bis(cyclopentadienyl)iron(II) (ferrocene, Fe (C₅H₅)₂), tris(2,4-pentanedionato)iron(III), bis(cyclopentadienyl)iron(II), and iron carbonyl; Co-containing catalyst raw material such as tris(2,4-pentanedionato)cob alt(III), bis(cyclopentadienyl)cobalt(II), cobalt nitrate (II) hexahydrate; Ni-containing catalyst materials such as bis(2,4-pentanedionato)nickel(II) hydrate and bis(cyclopentadienyl)nickel(II) and the like. Thereamong, from the viewpoints of the solubility and the ease of precipitation of the catalyst component, iron (II) acetate and iron (III) nitrate are specifically preferably used as the catalyst raw material.

[Supersaturation ratio]

Further, the supersaturation ratio of the catalyst raw material in the mixed solution is preferably 0.3 or more, more preferably 0.5 or more, and is preferably 1.0 or less. If the supersaturation ratio of the catalyst raw material in the mixed solution is the aforementioned lower limit or more, the catalyst component can be more efficiently precipitated and formed in the mixed layer with a high coverage, and the thickness of the catalyst component can be increased. In addition, as the catalyst component can be precipitated throughout the time from the start of the drying of the mixed solution prior to the repelling of the mixed solution, the mixed layer can be more uniformly formed. As a result, a high catalytic performance can be exhibited by the mixed layer. Further, if the supersaturation ratio of the catalyst raw material in the mixed solution is the aforementioned upper limit or less, the catalyst component can be prevented from precipitating from the mixed solution before the mixed solution is brought into contact with the support body. Moreover, for example, the segregation, in the more uniform mixed layer, of the catalyst components in step B which is described later becomes better, and the mixed layer can exhibit a higher catalytic performance.

Note that, in the present disclosure, “the supersaturation ratio” can be appropriately set by changing, for example, the concentration of the catalyst raw material and/or the catalyst carrier raw material in the mixed solution.

«Catalyst carrier raw material»

The catalyst carrier raw material is a raw material that constitutes the catalyst carrier component which plays a role as a co-catalyst which adequately supports the catalyst component on the support body. Moreover, examples of the catalyst carrier raw material preferably comprise elements such as Al, Si, Mg, Fe, Co, Ni, O, N, and C, and more preferably comprise elements such as Al, Si, and Mg, and furthermore, preferably comprises at least Al.

Specific examples of the catalyst raw material which can be suitable used include an aluminum alkoxide such as aluminum isopropoxide (Al(OCH (CH₃)₂)₃), aluminum acetate (Al(CH₃COO)₃), aluminum nitrate (Al(NO₃)₃) and the like. Thereamong, from the viewpoint that the catalyst component is adequately supported on the support body, the catalyst carrier raw material preferably uses an aluminum alkoxide, and more preferably uses aluminum isopropoxide.

[Supersaturation ratio]

Further, the supersaturation ratio of the catalyst carrier raw material in the mixed solution is preferably 0.3 or more, more preferably 0.5 or more, and is preferably 1.0 or less, and more preferably 0.95 or less. If the supersaturation ratio of the catalyst carrier raw material in the mixed solution is the aforementioned lower limit or more, the mixed layer can be precipitated and formed more efficiently on the support body with a high coverage. As a result, a high catalytic performance can be exhibited by the mixed layer. Further, if the supersaturation ratio of the catalyst carrier raw material in the mixed solution is the aforementioned upper limit or less, the catalyst carrier component can be prevented from precipitating from the mixed solution before the mixed solution is brought into contact with the support body. Moreover, the catalyst component can be adequately supported on the support body in a more uniform mixed layer, and thus, the mixed layer can exhibit a higher catalytic performance.

Furthermore, the absolute value of the difference between the supersaturation ratio of the catalyst raw material and the supersaturation ratio of the catalyst carrier raw material in the mixed solution is preferably 0.5 or less. If the absolute value of the difference between the supersaturation ratio of the catalyst raw material and the supersaturation ratio of the catalyst carrier raw material in the mixed solution is the aforementioned upper limit or less, when the mixed solution is applied by contact and dried to form a mixed layer, it is possible to suppress separation and precipitation by the catalyst component and the catalyst carrier component, and form a mixed layer in which the catalyst component and the catalyst carrier component are more uniformly present. Moreover, the mixed layer in which the catalyst component and the catalyst carrier component is more uniformly present has a better segregation of the catalyst component in step B which is described later, and furthermore, can exhibit a high catalytic performance.

[Concentration ratio]

Further, the concentration ratio (catalyst raw material/catalyst carrier raw material) of the catalyst raw material and the catalyst carrier raw material in the mixed solution, by molar concentration ratio, is preferably 0.1 or more, more preferably 0.2 or more, even more preferably 0.3 or more, preferably 5 or less, more preferably 4 or less, and even more preferably 3 or less. If the concentration of the catalyst raw material in the mixed solution is the aforementioned lower limit or more relative to the concentration of the catalyst carrier raw material, the catalyst component in the mixed layer is precipitated and formed more efficiently with high coverage. In addition, if the concentration of the catalyst raw material in the mixed solution is the aforementioned lower limit or more relative to the concentration of the catalyst carrier raw material, more catalyst components can segregate to the surface portion of the mixed layer more efficiently in step B which is described later, thus, a high catalytic performance can be further exhibited. Further, if the concentration of the catalyst raw material in the mixed solution is the aforementioned upper limit or less relative to the concentration of the catalyst carrier raw material, the catalyst carrier component in the mixed layer is precipitated and formed more efficiently with high coverage, and the catalyst component can be better supported, thus, a high catalytic performance can be further exhibited, and the coarsening of catalyst particles due to excessive surface segregation of the catalyst components can be suppressed.

«Additives»

Examples of the additives further comprised by the mixed solution include a reducing agent such as citric acid, ascorbic acid, oxalic acid, and formic acid and the like. A reducing agent such as citric acid can improve the stability of the mixed solution.

Moreover, the concentration of the additives in the mixed solution is not specifically limited, but may be made to, for example, 1 to 10 times the concentration of the aforementioned catalyst raw material.

«Solvent»

The solvent of the mixed solution is not specifically limited as long as it can adequately dissolve the aforementioned catalyst raw material and the catalyst carrier raw material, and examples of the solvent include water, and, various organic solvents such as alcohol-based solvents, ether, acetone, toluene. Thereamong, from the viewpoints of the solubility, and, the drying property in the case when, for example, the applied and in contact mixed solution is dried to form the mixed layer, the solvent is preferably an alcohol-based solvent, more preferably methanol, ethanol and 2-propanol, and even more preferably ethanol.

«Preparation method»

The mixed solution can be prepared by, for example, mixing and stirring, by any method, the aforementioned catalyst raw material, the catalyst carrier raw material, and commonly, the solvent with further additives in accordance with need. The stirring and mixing method is not specifically limited, and examples of the stirring and mixing method include using a general stirring device such as a magnetic stirrer and a mechanical stirrer. Further, the stirring temperature may be set to room temperature (about 23° C.), and the stirring time may be set from 30 seconds to one hour.

<Step A>

In step A which is included in the manufacturing method for the supported catalyst of the present disclosure, the mixed layer having the catalyst component and the catalyst carrier component is formed on at least a portion of the surface of the support body having the catalytic layer by bringing the mixed solution comprising the catalyst raw material and the catalyst carrier raw material into contact with the support body having the catalytic layer on the surface. In short, the mixed layer is a layer in which the catalyst component derived from the catalyst raw material and the catalyst carrier component derived from the catalyst carrier raw material are both present. In the mixed layer, the catalyst component is supported firmly to the support body, and thus, the supported catalyst can exhibit an excellent catalytic performance.

Therefore, in the manufacturing method for the supported catalyst of the present disclosure, it is possible to use the predetermined mixed solution to form the mixed layer having a high catalytic performance and including a well-supported catalyst component at one time without performing the formation of the catalyst carrier component and the support of the catalyst component separately. In other words, if the manufacturing method for the supported catalyst of the present disclosure does not include step A which forms the aforementioned predetermined mixed layer, it is not possible to obtain the supported catalyst having an excellent catalytic performance, and which can efficiently and repeatedly prepare the high quality carbon nanostructures even when the catalyst is repeatedly supported.

Furthermore, although, generally, it is difficult to form the catalyst component and the catalyst carrier component with a uniform film thickness by a wet process, if a mixed layer is formed by the manufacturing method of the present disclosure, even when there is a film thickness distribution in the mixed layer, the supported catalyst having an excellent catalytic performance can be efficiently manufactured due to the uniformity of the composition of the catalyst component and the catalyst carrier component.

Here, in step A, the same support body as that which can be prepared by the aforementioned “Step A1” item can be used as the support body having the catalytic layer on the surface.

Further, in step A, the same mixed solution as that which can be prepared by the aforementioned “Step A2” item can be used as the mixed solution comprising the catalyst raw material and the catalyst carrier raw material.

Further, in step A, when forming the mixed layer, only a contact treatment of the mixed solution may be performed to form the mixed layer by natural drying, and in addition to the aforementioned contact treatment, other treatments such as a drying treatment may be performed in any order to form the mixed layer. Furthermore, in step A, there is no specific limitation with the exception that the contact treatment of the mixed solution is performed at least once, and any of the aforementioned treatments may be performed any number of times continuously or discontinuously to form the mixed layer.

«Contact treatment»

The method for bringing the predetermined mixed solution into contact with the support body having the catalytic layer on the surface is not specifically limited as long as it is a method in which the aforementioned mixed solution is applied to and in contact with at least the aforementioned catalytic layer. Examples of the method for contacting with the mixed solution include,

1) a method for applying the mixed solution on the catalytic layer which the support body has on a surface;

2) a method for immersing the support body having the catalytic layer on the surface in the mixed solution; and

3) a method for supplying the mixed solution to the support body having the catalytic layer on the surface disposed in a container.

Thereamong, from the viewpoint of efficiently contacting with the mixed solution, the aforementioned methods 2) and 3) are preferable. These contact conditions can be appropriately adjusted in accordance with the desired properties of the mixed layer.

«Drying treatment»

The mixed solution which is applied to and in contact with the support body having the catalytic layer on the surface is normally dried by any method. Here, examples of the drying method include vacuum drying, air drying, high temperature drying, low temperature drying, the evaporation to dryness method, drying with a spray dryer, and drying with a drum dryer. Examples of the drying temperature include setting between 15° C. to 200° C. Further, the drying time may be appropriately selected in accordance with the method to be used. Moreover, the drying may be performed in the atmosphere; and may be performed under an inactive gas (non-oxidizing) environment such as argon, nitrogen and helium. By undergoing the drying treatment, the mixed layer can be formed more uniformly and more efficiently on the catalyst layer, and the catalyst component can be better supported.

«Mixed layer»

The mixed layer formed in step A has the catalyst component and the catalyst carrier component. The supported catalyst having an excellent catalytic performance can be repeatedly and efficiently obtained by forming the mixed layer having the catalyst component and the catalyst carrier component on at least a portion of the surface of the support body in which the support body has the catalytic layer, preferably on the entire surface. Therefore, if the obtained supported catalyst is used, high-quality carbon nanostructures can be efficiently and repeatedly prepared. Note that, the present disclosure does not exclude that the mixed layer of the support body is formed on a surface which does not have the catalytic layer.

Further, in the catalytic layer of the aforementioned “spent supported catalyst”, normally, the catalyst component moves in a direction toward the inside of the support body due to the high temperature environment when synthesizing carbon nanostructures, the carbon coating derived from a carbon material used in the synthesis of the carbon nanostructures cover the catalyst component surface, the catalyst component becomes deactivated by carbonization, and the catalytic performance is significantly reduced. However, in the manufacturing method for the supported catalyst of the present disclosure, the predetermined mixed solution is used to form the predetermined mixed layer, and thus, even when the “spent supported catalyst” was used, the supported catalyst in which the mixed layer was formed exhibits a high catalytic performance, and high quality carbon nanostructures can be repeatedly and efficiently manufactured.

[Catalyst component]

The catalyst component plays a role in the mediation, promotion, and improvement in the efficiency of the synthesis of the carbon nanostructures. Moreover, the catalyst component, for example, incorporates the carbon material which is a raw material of carbon nanostructures, discharges carbon nanostructures such as CNTs, and produces and grows carbon nanostructures on the mixed layer, specifically, on the catalyst component.

More specifically, for example, when the catalyst component is a catalyst particle having a fine particulate shape, each of the catalyst particles continues to produce carbon while manufacturing a tube-like structure having a diameter corresponding to the size of the catalyst particle, so that carbon nanostructures such as CNTs are synthesized and grown.

—Composition—

Further, the catalyst component is formed in the mixed layer as a dried product of the catalyst raw material, which is normally obtained by drying the catalyst raw material contained in the mixed solution. Therefore, the catalyst component preferably comprises at least one element selected from the group consisting of Fe, Co and Ni, and more preferably comprises at least Fe, even more preferably Fe, and most preferably the Fe particle.

—Existence location—

Further, according to the production and growth process of the aforementioned carbon nanostructures, the catalyst component preferably exists uniformly in the in-plane direction in the mixed layer so as to cover the support body and the catalytic layer. Further, the catalyst component has a distribution in the straight direction (thickness direction) of the mixed layer, and at least a part thereof preferably exists on the surface portion of the mixed layer, and more preferably, a large part thereof exists on the outermost surface of the mixed layer. Furthermore, the catalyst component preferably forms the nanoparticle structures at a high number density.

Note that, when the mixed layer is a multilayer, the catalyst component preferably exists in the surface portion of the entire multilayer.

[Catalyst carrier component]

The catalyst carrier component plays a role as a co-catalyst which adequately supports the catalyst component on the support body.

—Composition—

The catalyst carrier component is normally formed in the mixed layer as the dried product of the catalyst carrier raw material which is obtained by drying the catalyst carrier raw material contained in the mixed solution. Therefore, the catalyst carrier component preferably comprises elements such as Al, Si, Mg, Fe, Co, Ni, O, N, and C, more preferably comprises elements such as Al, Si, and Mg, and even more preferably comprises at least Al. Further, the catalyst carrier component is preferably an oxide of Al, and more preferably is Al₂O₃.

—Existence location—

Further, from the viewpoint that the catalyst component is well supported on the support body, the catalyst carrier component preferably exists uniformly in the in-plane direction in the mixed layer so as to cover the support body and the catalytic layer.

Note that, when the mixed layer is a multilayer, the catalyst carrier component preferably exists substantially uniformly in the entirety of the multilayer.

[Thickness of the mixed layer]

Moreover, the thickness of the formed mixed layer is preferably 3 nm or more, more preferably 5 nm or more, even more preferably 10 nm or more, most preferably 20 nm or more, and is preferably 200 nm or less, more preferably 100 nm or less, and even more preferably 50 nm or less. During the formation of the mixed layer and/or during the segregation of the catalyst component in step B which is described later, while the pre-catalyst component contained in the catalytic layer moves or diffuses to the upper part of the mixed layer to be added to the current catalyst component of the mixed layer surface, and, for example, the particle diameter of the current catalyst component is increased to easily deteriorate the catalyst performance, the aforementioned diffusion of the pre-catalyst component can be further suppressed if the thickness of the mixed layer is the aforementioned lower limit or more. Further, if the thickness of the mixed layer is the aforementioned upper limit or less, it is possible to suppress the formation of an extra mixed layer portion which does not contribute to the support of the catalyst component and to the synthesis of the carbon nanostructures, and subsequently, further improve the manufacturing efficiency. The aforementioned extra mixed layer portion is preferably not formed, as there is the risk that it will be mixed as an impurity in the synthesized carbon nanostructures.

Note that, when the mixed layer is a multilayer, it is preferable that the thickness of the entire multilayer is within a range which may be defined by multiplying the aforementioned upper and lower limit values in the preferred range by the number of layers.

Here, in the present disclosure, the “thickness of the mixed layer” can be approximated as an average thickness calculated by

Thickness of the mixed layer (nm)=Volume (nm³) of the formed mixed layer/Surface area (nm²) of the support body. When the mixed layer is a multilayer, the volume of the entirety of the formed multilayer can be obtained by fitting to the aforementioned equation.

Further, the “thickness of the mixed layer” can be appropriately adjusted by, for example, changing the conditions such as the concentration of the catalyst raw material and the catalyst carrier raw material, the contact time and the contact temperature of the mixed solution, and the number of times the mixed layer is formed.

<Step B>

Step B which the manufacturing method for the supported catalyst of the present disclosure may furthermore suitably comprise is performed after the aforementioned step A. Moreover, in step B, the catalyst component which the mixed layer formed in step A has is made to segregate to the surface portion of the mixed layer. In other words, in step B, the catalyst component is made to segregate to the surface portion of the supported catalyst. Therefore, by making the catalyst component segregate to the surface portion of the mixed layer, even when repeatedly supporting the catalyst, the catalytic ability of the supported catalyst can be further improved.

Furthermore, generally, it is difficult to form the catalyst component and the catalyst carrier component with a uniform film thickness by a wet process, and after performing step B, even when there is a film thickness distribution in the mixed layer, the catalyst component is segregated on the surface portion of the mixed layer from a constant depth from the surface of the mixed layer, thus, an effective amount (the film thickness of the catalyst component existing on the mixed layer surface) of the catalyst component can be made uniform, and the catalytic performance of the supported catalyst can be further increased.

Further, in the mixed layer, for example, Fe (II) and Fe (III) such as FeO, Fe₃O₄, and Fe₂O₃ derived from the catalyst raw material comprising Fe may exist in the mixed layer. Therefore, after performing step B, while reducing Fe (II) and Fe (III) which may exist in the mixed layer to zero-valent Fe, by segregating the zero-valent Fe in the surface portion of the mixed layer to form the Fe nanoparticle, the catalytic ability of the supported catalyst can be further increased even when repeatedly supporting the catalyst.

Here, making the catalyst component which is segregated to the surface portion of the mixed layer as the aforementioned nanoparticle is preferred as, for example, carbon nanostructures such as CNTs can be produced with a diameter corresponding to the fine diameter of the catalyst component.

Moreover, from the viewpoint that the catalyst component is made to adequately segregate to the surface portion of the mixed layer, and, the viewpoint that the catalyst component which segregated to the surface portion of the mixed layer is made as a nanoparticle, step B is preferably performed by applying the reducing agent to the mixed layer.

Note that, from the viewpoint of increasing the catalytic performance of the supported catalyst, it is preferable that the catalyst component is present in an amount of 10% or more of the entirety of the catalyst component in the mixed layer exposed on the surface, and is more preferably present in amount of 20% or more exposed on the surface.

Note that, the configuration of the supported catalyst can be verified using, for example, a scanning electron microscope (SEM) to observe the cross-section of the supported catalyst. Further, the configuration of the supported catalyst can verify the depth distribution of the catalyst component using Ar⁺ ion etching in combination with X photoelectron spectroscopy.

«Reduction»

The reducing agent is not specifically limited, and a reducing gas such as hydrogen and ammonia may be used. Further, the reducing gas may also be used with any inactive gas such as nitrogen and argon.

Here, the application of the reducing agent can be performed by, for example, supplying the aforementioned reducing gas to the formed mixed layer. The reduction temperature may be set from 400° C. to 1000° C., and the reduction time can be appropriately adjusted in accordance with the size of the supported catalyst, the thickness of the mixed layer and the like.

«Segregated catalyst component»

—Thickness—

The thickness of the catalyst component which segregated to the surface portion of the mixed layer is preferably 0.1 nm or more, more preferably 0.3 nm or more, and is preferably 10 nm or less, more preferably 5 nm or less, and even more preferably 3 nm or less. If the catalyst component having a thickness of the aforementioned lower limit or more is segregated to the surface portion of the mixed layer, the catalytic performance of the surface of the supported catalyst further increases, and the high-quality carbon nanostructures can be efficiently and repeatedly prepared. Further, if the thickness of the catalyst component which segregated to the surface portion is the aforementioned upper limit or less, the manufacturing efficiency of the carbon nanostructures having a small diameter can further increase without the catalyst component forming excessively large particles.

Note that, in the present disclosure, the “thickness of segregated catalyst component” uses X photoelectron spectroscopy and Secondary Ion Mass Spectrometry (SIMS) to measure the amount of catalyst component, and can be calculated by converting to film thickness.

Further, the “thickness of segregated catalyst component” can be adjusted by, for example, changing the conditions such as the type of catalyst raw material, the catalyst raw material concentration, the contact temperature and the contact time of the mixed solution, the reduction temperature and the reduction time.

—Particle diameter—

Further, when the catalyst component which segregated to the surface portion of the mixed layer is nanoparticles, the particle diameter of the catalyst component is the number-average particle diameter and is preferably 1 nm or more, more preferably 2 nm or more, and is preferably 30 nm or less, more preferably 20 nm or less, and even more preferably 15 nm or less. If the particle diameter of the catalyst component which segregated to the surface portion is the aforementioned upper limit or less, higher quality carbon nanostructures such as CNTs having a finer diameter can be repeatedly produced in accordance with the diameter of the finer catalyst component. In addition, if the particle diameter of the catalyst component which segregated to the surface portion is the aforementioned upper limit or less, the number density of the catalyst component of the supported catalyst surface increases, thus, high-quality carbon nanostructures such as CNTs can be more finely and repeatedly prepared. Further, if the particle diameter of the catalyst component which segregated to the surface portion is the aforementioned lower limit or more, the high catalytic performance of the catalyst component can be maintained, and high-quality carbon nanostructures can be efficiently and repeatedly prepared.

Note that, the “number-average particle diameter” of the catalyst component can be obtained using the relational expression πd³/6=Z to calculate d nm for 100 catalyst components (catalyst particles) observed by a scanning electron microscope (SEM), from the average volume (Z=XY/100 nm³) of the catalyst particles calculated using the observation range (X nm²) and the average film thickness (Y nm) of the catalyst component. Further, the “number-average particle diameter” of the catalyst component can be adjusted by, for example, changing the conditions such as the type of catalyst raw material, the catalyst raw material concentration, the contact temperature and the contact time of the mixed solution, the reduction temperature and the reduction time.

(Method of manufacturing the carbon nanostructures)

The method of manufacturing the carbon nanostructures of the present disclosure comprises a step C which uses the supported catalyst obtained by any of the aforementioned manufacturing methods to produce the carbon nanostructure. Further, in the method of manufacturing the carbon nanostructure of the present disclosure, the carbon nanostructure is usually produced on the mixed layer of the aforementioned supported catalyst, preferably, on the catalyst component which segregated to the surface portion of the mixed layer. Moreover, the method of manufacturing the carbon nanostructures of the present disclosure uses the supported catalyst obtained by any of the aforementioned manufacturing methods, thus, high-quality carbon nanostructures can be efficiently and repeatedly prepared.

Here, the method of manufacturing the carbon nanostructures of the present disclosure can be suitably used in the method of manufacturing the fibrous carbon nanostructures, and can be more suitably used in the manufacture of CNTs.

<Step C>

In step C for the method of manufacturing the carbon nanostructures of the present disclosure, the supported catalyst obtained by any of the aforementioned manufacturing method is used to synthesize the carbon nano structures.

Here, examples of the carbon nanostructure which can be synthesized by step C include graphene; a fibrous carbon nanostructure such as a carbon nanocoil in which carbon fibers are wound in a coil shape, a CNT in which graphene forms a tubular shape, a carbon nanotwist in which a CNT is twisted; and the like. Thereamong, as the carbon nanostructures, fibrous carbon nanostructures are preferable, and CNTs are more preferable.

«Synthesis method»

A general CVD method may be used as a suitable synthesis method of the carbon nanostructures. The synthesis conditions may be appropriately set in accordance with the desired type of carbon nanostructures, the particle diameter, the length and the like.

Thereamong, examples of the synthesis method of the carbon nanostructures include a fluidized bed CVD method which can be suitably used when the support body is a powder or a particulate; and, for example, when the support body is net-shaped, plate-shaped, or film-shaped, a fixed bed CVD method, and notably, the super growth method can be suitably used.

Note that, even though an example of the synthesis method of a carbon nanostructure using a fluid bed CVD method is described below, the present disclosure is not limited thereto.

[Fluid bed CVD method]

—Catalyst activation of catalyst component—

The supported catalyst obtained by any of the aforementioned manufacturing methods is filled in any fluidized bed device. Next, a reducing gas and any additive gas environment are set in the fluidized bed device, and the temperature is raised to a reduction reaction temperature to reduce the catalyst component of the supported catalyst. The catalyst component of the supported catalyst can be subjected to catalyst activation thereby.

Here, examples of the reducing gas include hydrogen, and nitrogen, argon, carbon dioxide and the like as an additive gas. Further, the reduction temperature can be set from 400° C. to 1000° C., and the reduction time can be set from 10 seconds to 60 minutes.

Here, the supported catalyst obtained by the manufacturing method of the present disclosure has an excellent catalytic performance, thus, high-quality carbon nanostructures can be manufactured without performing a catalyst activation treatment. However, the supported catalyst has a mixed layer, specifically, the surface of which is oxidized by the catalyst component in contact with the atmosphere, and the catalytic activity may decrease. Therefore, in the method of manufacturing the carbon nanostructures of the present disclosure, the catalyst component of the supported catalyst is preferably subjected to catalyst activation, so that the high catalytic performance of the supported catalyst can be reliably exhibited in the supported catalyst.

—Supply of the carbon material—

Next, a carbon material gas containing a carbon material for constituting the carbon nanostructures is supplied into the fluidized bed device in which the catalyst activated supported catalyst exists. Here, an inactive gas, a reduction gas and an oxygen element-containing gas may be further included in the carbon material gas in accordance with need. The aforementioned inactive gas and the reduction gas can be used as the inactive gas and reduction gas. Further, examples of the oxygen element-containing gas include air, oxygen, water vapor, and/or carbon dioxide. Specifically, carbon dioxide makes it possible to suppress deactivated by carbonization of the catalyst component in the synthesis of the carbon nanostructures so as to supply the carbon material at a high concentration, and can further increase the manufacturing efficiency of the carbon nanostructures.

—Carbon material—

Further, the carbon material contained in the carbon material gas is not specifically limited, and examples of the carbon material include alkanes (paraffin hydrocarbons) such as methane, ethane, propane, and butane; alkenes (olefin hydrocarbons) such as ethylene, propylene and butylene; alkynes (acetylene hydrocarbons) such as acetylene, methyl acetylene, 1-butyne and 2-butyne; alcohols; ethers; aldehydes; ketones; aromatics, carbon monoxide; and the like. Thereamong, alkenes and alkynes having excellent reaction activities are preferable, and ethylene and acetylene are more preferable. These carbon materials may be used singly or in combinations of two or more at any ratio.

Here, it is preferable that all of the carbon material is supplied in a gaseous state, but a carbon material which is liquid at a normal temperature and a normal pressure or which is solid at a normal temperature and a normal pressure may be supplied in the fluidized bed device and the carbon material may be evaporated due to the heat of the heating environment in the fluidized bed device.

Note that, in the present disclosure, the phrase “normal temperature” refers to 23° C., and the phrase “normal pressure” refers to 1 atm.

—Synthesis conditions—

The pressure of the carbon material gas supplied is not specifically limited, and, for example, may be set from 0.001 MPa to 1.500 MPa. Further, the temperature in the fluidized bed device during the synthesis of the carbon nanostructures is set from 600° C. to 900° C.

The time required for the synthesis of the carbon nanostructures, the flow rate of the carbon material gas to be supplied, the concentration of the carbon material in the carbon material gas to be supplied and the like can be appropriately set in accordance with the desired properties of the carbon nanostructures and the size of the reactor. The length of the carbon nanostructures can be increased, for example, by increasing the synthesis time. Further, the manufacturing efficiency of the carbon nanostructures may be improved by increasing the concentration of the carbon material in the carbon material gas.

«Properties of the carbon nanostructures»

When the obtained carbon nanostructures are, for example, CNTs, it is preferable that the CNTs are long and synthesized radially from the surface of the supported catalyst when the support body is a particulate, and in the vertical direction from the surface of the supported catalyst when the support body is a plate-shape.

Further, the CNTs as the obtained carbon nanostructures preferably have a diameter of 0.4 nm or more and 20 nm or less. Further, the CNTs as the obtained carbon nanostructures preferably have a length of the structure during the synthesis of 50 μm or more and 5000 μm or less. Furthermore, the CNTs as the obtained carbon nanostructures preferably have a specific surface area of 300 m²/g or more.

Note that, in the present disclosure, the “diameter” and the “length” of the CNTs can be measured using, for example, a transmission electron microscope (TEM). Further, in the present disclosure, the “specific surface area” refers to the nitrogen adsorption specific surface area measured using the BET method.

### EXAMPLES

The present disclosure will be specifically described below based on the examples, but the present disclosure is not limited to these examples. Moreover, in the examples and the comparative examples, the success or failure of CNT synthesis was measured/evaluated as follows.

<Success or failure of CNT synthesis>

The surface of the supported catalyst was observed with a scanning electron microscope (SEM) after CNT synthesis treatment was performed to the examples and the comparative examples. Moreover, the success or failure of CNT synthesis was evaluated by the following two criteria for five supported catalysts randomly selected from among the supported catalysts verified in the observation field of view. The better the evaluation of the CNT coating area, the higher the catalytic performance of the obtained supported catalyst. In addition to the evaluation of the CNT coating area being good, the longer the length of the obtained CNTs, the more excellent the catalytic performance. Moreover, if the catalytic performance is high, it suggests that the quality of the obtained CNTs is high.

[CNT coating area]

A: 80% or more of the surface is covered with CNTs for all 5 supported catalysts.

B: While 30% or more of the surface is covered with CNTs for all 5 supported catalysts, 30% to less than 80% of the surface is covered with CNT for 1 or more of the supported catalysts.

C: One or more among the 5 supported catalysts had less than 30% of the surface covered with CNTs.

[CNT length]

A: CNTs having a length of 50 μm or more were recognized in any of the 5 supported catalysts.

B: CNTs of 50 μm or more were not recognized, but CNTs having a length of 30 μm to less than 50 μm were recognized in any of the 5 supported catalysts.

C: CNTs having a length of 30 μm or more were not recognized in any of the 5 supported catalysts.

(Example 1)

<Preparation of support body having the catalytic layer on the surface>

[Filling of support body]

10 g of alumina beads (apparent density: 3.9 to 4.0 g/cm³, volume average particle diameter D50: 0.1 mm) as the support body were filled in a container consisting of a 2.2 cm internal diameter quartz tube having a porous plate at the bottom.

[First round of contact application of the mixed solution]

Next, a separately prepared ethanol mixed solution comprising 30 mmol/L iron (II) acetate and 36 mmol/L aluminum isopropoxide was supplied into the container, and the alumina beads filled in the container was immersed. Next, nitrogen gas was flown from an upper tube connected to the upper part of the quartz tube, the excess mixed solution was removed from the quartz tube, and the alumina beads to which the mixed solution was applied in contact were dried in an environment having a normal temperature (23° C.) to obtain alumina beads to which the dried product of the mixed solution was adhered.

[Decomposition of the dried product of the mixed solution]

Next, the filled layer of alumina beads on which the dried product of the aforementioned mixed solution was formed was stirred by vibrating the quartz tube. Further, 0.1 mol/L ammonia water was supplied to the filled layer after stirring to decompose the dried product of the mixed solution formed on the alumina beads. Furthermore, heated nitrogen gas was flown from the upper tube connected to the upper part of the quartz tube, the ammonia water was removed from the quartz tube, and the filled layer of the alumina beads was dried in an environment having a temperature of 100° C. to 150° C. to obtain alumina beads on which a decomposed dried product of the mixed solution was formed.

[Second round of contact application of the mixed solution]

Furthermore, the same steps as in the aforementioned “contact application of the mixed solution” were repeated for the alumina beads on which the decomposed dried product of the mixed solution was formed. The alumina beads having an unused catalytic layer on the surface were obtained thereby.

[Synthesis of CNTs]

Furthermore, after using the alumina beads having the unused catalytic layer on the surface to perform sintering, the synthesis of CNTs was performed. Note that, the sintering and the synthesis of CNTs were performed according to the same methods as the “Segregation treatment of the catalyst component” and the “Synthesis treatment of CNTs” which is described later. The alumina beads having a synthesized catalytic layer could be obtained thereby.

[Peeling of CNTs]

Furthermore, the CNTs were peeled from the alumina beads having the synthesized catalytic layer by subjecting the alumina beads having the obtained synthesized catalytic layer to an ultrasonic treatment in an ethanol solution, and dispersing the synthesized CNTs in an ethanol solution. The alumina beads having the spent catalytic layer on the surface were obtained as the support body having the catalytic layer on the surface thereby.

<Manufacture of the supported catalyst>

[Preparation of the mixed solution]

30 mmol/L iron (II) acetate as the catalyst raw material and 36 mmol/L aluminum isopropoxide as the catalyst carrier raw material were mixed and dissolved in ethanol as the solvent to prepare an ethanol mixed solution comprising the catalyst raw material and the catalyst carrier raw material. At this time, the supersaturation ratio of the catalyst raw material in the mixed solution was 0.75 to 1.0, and the supersaturation ratio of the catalyst carrier raw material in the mixed solution was 0.5.

Note that, in calculating the supersaturation ratio, the solubility of the iron (II) acetate: 30×10⁻³ mol/L to 40×10⁻³ mol/L, and, the solubility of the aluminum isopropoxide: 72×10⁻³ mol/L determined by experiment were used.

[Formation of the mixed layer]

Approximately 3 g of the alumina beads having the spent catalytic layer on the surface obtained as stated above were filled in the same container as the container used in the aforementioned “Preparation of support body having the catalytic layer on the surface”.

Next, the mixed solution obtained as stated above was supplied into the container, and the support body having the catalytic layer on the surface which was filled in the container was immersed (contacted) in the mixed solution. Next, the nitrogen gas was flown from an upper tube connected to the upper part of the quartz tube, the excess mixed solution was removed from the quartz tube, and the applied in contact mixed solution was dried in an environment having a normal temperature (23° C.). The mixed layer was formed on the catalytic layer which the support body has on the surface to obtain a pre-segregated supported catalyst thereby.

[Segregation treatment of the catalyst component]

A quartz boat accommodating the pre-segregated supported catalyst obtained as stated above was arranged in a horizontal cylindrical CVD device, a 475 sccm mixed gas comprised of 50 sccm of hydrogen, 5 sccm of carbon dioxide, and 420 sccm argon as the reducing agent was flown at a normal pressure, while raising the temperature to 800° C., and maintained for 5 minutes to reduce the mixed layer formed on the surface of the supported catalyst. The supported catalyst in which the catalyst component was segregated to the surface portion of the mixed layer was obtained thereby.

<Synthesis treatment of CNTs>

Moreover, the supported catalyst obtained as stated above was used in the CNT synthesis device, and a 500 sccm mixed gas comprised of 5 sccm acetylene (C₂H₂) as the carbon material, 50 sccm of hydrogen, 5 sccm of carbon dioxide and 440 sccm argon was supplied at a normal pressure for 10 minutes to perform the synthesis treatment of CNTs.

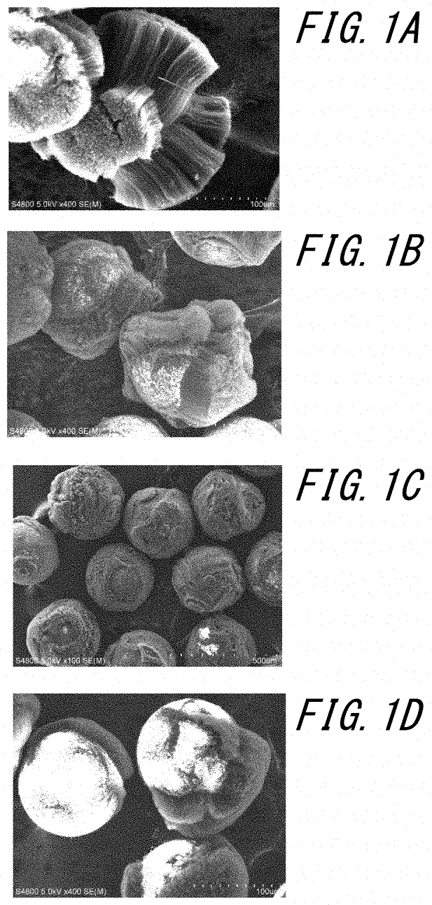

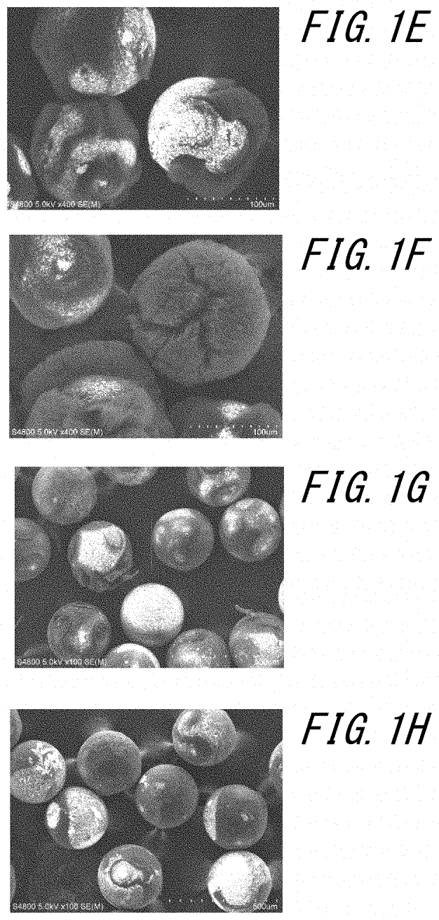

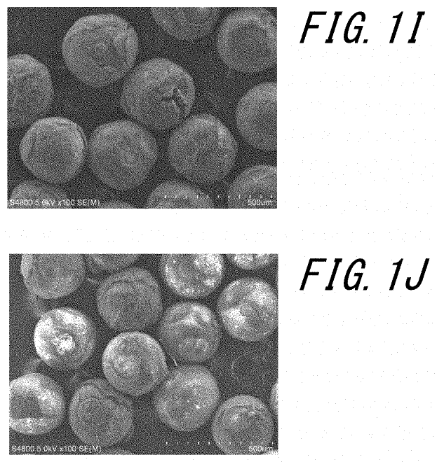

Moreover, the success or failure of the synthesis of CNTs was evaluated for the supported catalysts to which the synthesis treatment of CNTs was performed according to the above stated method. The results are shown in Table 1 and FIG. 1A.

(Example 2)

Alumina beads having the unused catalytic layer on the surface were prepared as the support body having the catalytic layer on the surface. Moreover, the alumina beads having the unused catalytic layer on the surface were used in the manufacturing of the supported catalyst. Except for the aforementioned preparation of the support body having the catalytic layer on the surface, the manufacture of the supported catalyst and the synthesis treatment of CNTs were performed in the same manner as Example 1.

Moreover, the success or failure of the synthesis of CNTs was evaluated in accordance with the above stated method in the same manner as Example 1. The results are shown in Table 1 and FIG. 1B.

(Example 3)

In the preparation of the support body having the catalytic layer on the surface, alumina beads (apparent density: 3.9 to 4.0 g/cm³, volume average particle diameter D50: 0.3 mm) having a different particle diameter from those in Example 1 were used as the support body, the decomposition of the dried product of the mixed solution and the second round of contact application of the mixed solution was not performed, and only the first round of contact application of the mixed solution was performed. Except for the aforementioned preparation of the alumina beads having the spent catalytic layer on the surface as the support body having the catalytic layer on the surface, the manufacture of the supported catalyst and the synthesis treatment of CNTs were performed in the same manner as Example 1.

Moreover, the success or failure of the synthesis of CNTs was evaluated in accordance with the above stated method in the same manner as Example 1. The results are shown in Table 1 and FIG. 1C.

(Example 4-1 and Example 4-2)

<Preparation of support body having the catalytic layer on the surface>

[Filling of support body]

Approximately 30 g of zirconia beads (apparent density: 6.0 g/cm³, volume average particle diameter D50: 0.2 mm) as the support body were filled in the container consisting of a 2.2 cm internal diameter quartz tube having a porous plate at the bottom.

[Contact application of the mixed solution]

Next, a separately prepared ethanol mixed solution comprising 30 mmol/L iron (II) acetate and 36 mmol/L aluminum isopropoxide was supplied into the container, and the zirconia beads filled in the container was immersed. Next, nitrogen gas was flown from an upper tube connected to the upper part of the quartz tube, the excess mixed solution was removed from the quartz tube, and the zirconia beads to which the mixed solution was applied in contact were dried in an environment having a normal temperature (23° C.) to obtain zirconia beads to which the dried product of the mixed solution was adhered. The zirconia beads having the unused catalytic layer on the surface were obtained thereby.

[Synthesis of CNTs]

Furthermore, after sintering using the zirconia beads having the unused catalytic layer on the surface, the synthesis of CNT was performed. Note that, the sintering and the synthesis of CNTs were performed according to the same methods as the “Segregation treatment of the catalyst component” and the “Synthesis treatment of CNTs” which is described later (The synthesis result is shown in Table 1 and FIG. 3 as Comparative Example 7). The zirconia beads having the synthesized catalytic layer were obtained thereby.

[Peeling of CNTs]

Furthermore, the CNTs were peeled from the zirconia beads having the synthesized catalytic layer by subjecting the zirconia beads having the obtained synthesized catalytic layer to an ultrasonic treatment in an isopropyl alcohol solution. The zirconia beads having the spent catalytic layer on the surface were obtained as the support body having the catalytic layer on the surface thereby.

<Manufacture of supported catalyst>

[Preparation of mixed solution]

The ethanol mixed solution was prepared in the same manner as Example 1.

[Formation of mixed layer]

Approximately 30 g of the zirconia beads having the spent catalytic layer on the surface obtained as stated above were filled in the same container as the container used in the aforementioned “Preparation of support body having the catalytic layer on the surface”.

Next, the mixed solution obtained as stated above was supplied into the container, and the support body having the catalytic layer on the surface which was filled in the container was immersed (contacted) in the mixed solution. Next, the nitrogen gas was flown from an upper tube connected to the upper part of the quartz tube, the excess mixed solution was removed from the quartz tube, and the applied in contact mixed solution was dried in an environment having a normal temperature (23° C.). The mixed layer was formed on the catalytic layer which the support body has on the surface to obtain a pre-segregated supported catalyst thereby.

[Segregation treatment of the catalyst component]

The pre-segregated supported catalyst obtained as stated above was arranged in a horizontal cylindrical CVD device, a 2000 sccm mixed gas comprised of 200 sccm of hydrogen, 10 sccm of carbon dioxide, and 1790 sccm nitrogen as the reducing agent was flown at a normal pressure to flow the supported catalyst while raising the temperature to 800° C., and maintaining for 5 minutes, to reduce the mixed layer formed on the surface of the supported catalyst. The supported catalyst in which the catalyst component was segregated to the surface portion of the mixed layer was obtained thereby.

<Synthesis treatment of CNTs>

Moreover, the supported catalyst obtained as stated above was used in the CNT synthesis device, and a 2000 sccm mixed gas comprised of 20 sccm acetylene (C₂H₂) as the carbon material, 200 sccm of hydrogen, 10 sccm of carbon dioxide, 80 sccm argon and 1690 sccm nitrogen was supplied at a normal pressure for 20 minutes to perform the synthesis treatment of CNTs. Namely, the mixed layer of the catalyst component and the support component was supported on a bead having one spent catalytic layer to perform CNT synthesis using a catalyst in which the catalyst component was reduced and segregated.

Moreover, by repeating the [Peeling of CNTs], the [Formation of mixed layer] and the [Segregation treatment of the catalyst component] <Synthesis treatment of CNTs>in the same manner as described above in the present example, the mixed layer of the catalyst component and the support component is supported on a bead having two spent catalytic layers to perform CNT synthesis using a catalyst in which the catalyst component was reduced and segregated (Example 4-1). By repeating the same operation two times, the mixed layer of the catalyst component and the support component is supported on a bead having four spent catalytic layers to perform CNT synthesis using a catalyst in which the catalyst component was reduced and segregated (Example 4-2).

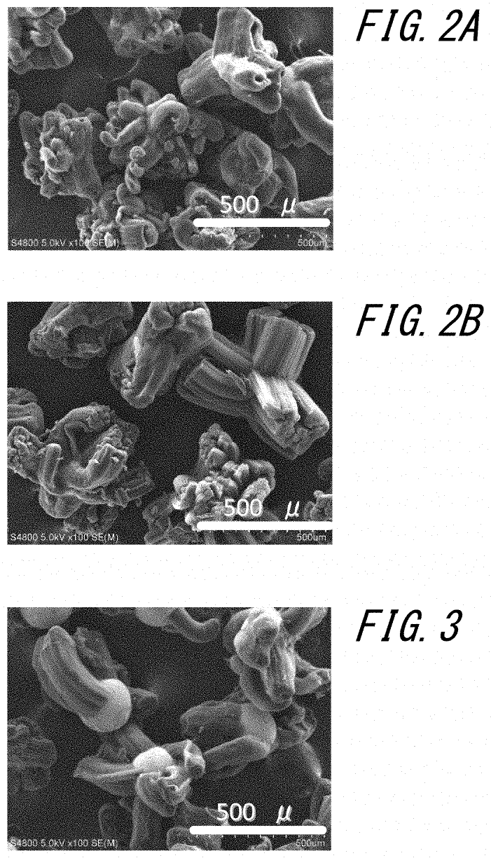

Moreover, the success or failure of the synthesis of CNTs was evaluated for the supported catalysts to which the synthesis treatment of CNTs was performed according to the above stated method. The results are shown in Table 1 and FIG. 2A (Example 4-1) and FIG. 2B (Example 4-2).

(Comparative Example 1)

The preparation of the support body having the catalytic layer on the surface was not performed. Moreover, in the manufacture of the supported catalyst, the alumina beads (apparent density: 3.9 to 4.0 g/cm³, volume average particle diameter D50: 0.1 mm) were used as is. Except for the aforementioned manufacture of the supported catalyst and the synthesis treatment of CNTs were performed in the same manner as Example 1.

Moreover, the success or failure of the synthesis of CNTs was evaluated in accordance with the above stated method in the same manner as Example 1. The results are shown in Table 1 and FIG. 1D.

(Comparative Example 2)

With the exception that the supported catalyst was not manufactured, and the synthesis treatment of CNTs was performed using the alumina beads having the spent catalytic layer on the surface as is as the support body having the catalytic layer on the surface, the preparation of the support body having the catalytic layer on the surface and the synthesis treatment of CNTs were performed in the same manner as Example 1.

Moreover, the success or failure of the synthesis of CNTs was evaluated in accordance with the above stated method in the same manner as Example 1. The results are shown in Table 1 and FIG. 1E.

(Comparative Example 3)

In the manufacturing of the supported catalyst, an ethanol solution of iron (II) acetate was prepared by mixing and dissolving 30 mmol/L iron (II) acetate as the catalyst raw material in ethanol as a solvent without preparing the mixed solution. At this time, the supersaturation ratio of the catalyst raw material in the ethanol solution was 0.75 to 1.0. Except for the aforementioned preparation of the alumina beads having the spent catalytic layer on the surface as the support body having the catalytic layer on the surface, the manufacture of the supported catalyst in which only the catalyst component is formed on the surface, and, the synthesis treatment of CNTs were performed in the same manner as Example 1.

Moreover, the success or failure of the synthesis of CNTs was evaluated in accordance with the above stated method in the same manner as Example 1. The results are shown in Table 1 and FIG. 1F.

(Comparative Example 4)

With the exception that alumina beads (apparent density: 3.9 to 4.0 g/cm³, volume average particle diameter D50: 0.3 mm) having a different particle diameter from those in Comparative Example 1 were used, the manufacture of the supported catalyst and the synthesis treatment of CNTs were performed in the same manner as Comparative Example 1.

Moreover, the success or failure of the synthesis of CNTs was evaluated in accordance with the above stated method in the same manner as Example 1. The results are shown in Table 1 and FIG. 1G.

(Comparative Example 5)

In the preparation of the support body having the catalytic layer on the surface, alumina beads (apparent density: 3.9 to 4.0 g/cm³, volume average particle diameter D50: 0.3 mm) having a different particle diameter from those in Example 1 were used as the support body, and only the first round of contact application of the mixed solution was performed without performing the decomposition of the dried product of the mixed solution and the second round of contact application of the mixed solution. Except for the aforementioned preparation of the alumina beads having the spent catalytic layer on the surface as the support body having a catalytic layer on the surface and the synthesis treatment of CNTs were performed in the same manner as Comparative Example 2.

Moreover, the success or failure of the synthesis of CNTs was evaluated in accordance with the above stated method in the same manner as Example 1. The results are shown in Table 1 and FIG. 1H.

(Comparative Example 6)

In the preparation of the support body having the catalytic layer on the surface, alumina beads (apparent density: 3.9 to 4.0 g/cm³, volume average particle diameter D50: 0.3 mm) having a different particle diameter from those in Example 1 were used as the support body, and only the first round of contact application of the mixed solution was performed without performing the decomposition of the dried product of the mixed solution and the second round of contact application of the mixed solution. Moreover, in the manufacture of the supported catalyst, except for the aforementioned preparation of the alumina beads having the spent catalytic layer on the surface as the support body having the catalytic layer on the surface, the manufacture of the supported catalyst in which only the catalyst component is formed on the surface, and, the synthesis treatment of CNTs were performed in the same manner as Comparative Example 3.

Moreover, the success or failure of the synthesis of CNTs was evaluated in accordance with the above stated method in the same manner as Example 1. The results are shown in Table 1 and FIGS. 1I to 1J.

In Comparative Example 6, CNTs could not be stably synthesized, and thus, the success or failure of the synthesis of CNT could not be univocally evaluated.

(Comparative Example 7)

The same operations as the operations described in the items <Preparation of support body having the catalytic layer on the surface>[Filling of support body], [Contact application of the mixed solution], and [Synthesis of CNTs] of Example 4 were performed to synthesize the CNTs. Moreover, the success or failure of the synthesis of CNTs was evaluated in accordance with the above stated method in the same manner as Example 1. The results are shown in Table 1 and FIG. 3.

Note that, in Table 1 shown below,

“AliP” refers to aluminum isopropoxide, and

“CNT” refers to carbon nanotube.

TABLE 1

| | | | | | | | | Example | |
|---|---|---|---|---|---|---|---|---|---|
| | | | | | Example 1 | Example 2 | Example 3 | 4-1 | Example 4-2 |
| Supported | Support body having | | Support body | Volume average particle | 0.1 | 0.1 | 0.3 | — | — |
| catalyst | catalytic layer on | | (alumina beads) | diameter [mm] | | | | | |
| | surface | | Support body | Volume average particle | — | — | — | 0.2 | 0.2 |
| | (however, regarding | | (zirconia beads) | diameter [mm] | | | | | |
| | Comparative examples | | Catalytic layer (Fe) | Number of layers | 2 | 2 | 1 | 2 | 4 |
| | 1,4 and 7, only the | | Number of rounds of CNT synthesis [No.] | | 1 | 0 | 1 | 2 | 4 |
| | support body) | | | | | | | | |
| | Contract | Mixed | Catalyst raw material | Type | Iron (II) | Iron (II) | Iron (II) | Iron (II) | Iron (II) |
| | treatment | solution | | | acetate | acetate | acetate | acetate | acetate |
| | | | | Concentration [10⁻³ mol/L] | 30 | 30 | 30 | 30 | 30 |
| | | | | Supersaturation ratio [—] | 0.75-1.0 | 0.75-1.0 | 0.75-1.0 | 0.75-1.0 | 0.75-1.0 |
| | | | Catalyst carrier raw | Type | AliP | AliP | AliP | AliP | AliP |
| | | | material | Concentration [10⁻³ mol/L] | 36 | 36 | 36 | 36 | 36 |
| | | | | Supersaturation ratio [—] | 0.50 | 0.50 | 0.50 | 0.50 | 0.50 |

| | | | | | |
|---|---|---|---|---|---|
| Concentration ratio of catalyst raw material/catalyst | 0.83 | 0.83 | 0.83 | 0.83 | 0.83 |
| carrier raw material (Fe/Al) [—] | | | | | |
| Absolute value of differnce of supersaturation ratios | 0.25-0.5 | 0.25-0.5 | 0.25-0.5 | 0.25-0.5 | 0.25-0.5 |
| (\|catalyst raw material − catalyst carrier | | | | | |
| raw materia\|) [—] | | | | | |

| | | | | | |
|---|---|---|---|---|---|
| Number of rounds of treatment [No.] | 1 | 1 | 1 | 1 | 1 |

| | | | | | | | |
|---|---|---|---|---|---|---|---|
| Mixed layer | Catalytic component | Type | Fe | Fe | Fe | Fe | Fe |
| (however, regarding | Catalyst carrier | Type | Al₂O₃ | Al₂O₃ | Al₂O₃ | Al₂O₃ | Al₂O₃ |
| Comparative examples | component | | | | | | |
| 3 and 6, only the | | | | | | | |
| catalytic component) | | | | | | | |

| | | | | | | |
|---|---|---|---|---|---|---|
| Evaluation item | CNT coating area | A | A | A | A | A |
| (Success or failure of CNT | CNT length | A | B | A | A | A |
| synthesis) | | | | | | |

| | | | | | Comparative | Comparative | Comparative | Comparative |
|---|---|---|---|---|---|---|---|---|
| | | | | | Example 1 | Example 2 | Example 3 | Example 4 |
| Supported | Support body having | | Support body | Volume average particle | 0.1 | 0.1 | 0.1 | 0.3 |
| catalyst | catalytic layer on | | (alumina beads) | diameter [mm] | | | | |
| | surface | | Support body | Volume average particle | — | — | — | — |
| | (however, regarding | | (zirconia beads) | diameter [mm] | | | | |
| | Comparative examples | | Catalytic layer (Fe) | Number of layers | — | 2 | 2 | — |
| | 1,4 and 7, only the | | Number of rounds of CNT synthesis [No.] | | | 1 | 1 | |
| | support body) | | | | | | | |
| | Contract | Mixed | Catalyst raw material | Type | Iron (II) | — | Iron (II) | Iron (II) |
| | treatment | solution | | | acetate | | acetate | acetate |
| | | | | Concentration [10⁻³ mol/L] | 30 | | 30 | 30 |
| | | | | Supersaturation ratio [—] | 0.75-1.0 | | 0.75-1.0 | 0.75-1.0 |
| | | | Catalyst carrier raw | Type | AliP | | — | AliP |
| | | | material | Concentration [10⁻³ mol/L] | 36 | | | 36 |
| | | | | Supersaturation ratio [—] | 0.50 | | | 0.50 |

| | | | |
|---|---|---|---|
| Concentration ratio of catalyst raw material/catalyst | 0.83 | — | 0.83 |
| carrier raw material (Fe/Al) [—] | | | |
| Absolute value of differnce of supersaturation ratios | 0.25-0.5 | — | 0.25-0.5 |
| (\|catalyst raw material − catalyst carrier | | | |
| raw materia\|) [—] | | | |

| | | | |
|---|---|---|---|
| Number of rounds of treatment [No.] | 1 | 1 | 1 |

| | | | | | | |
|---|---|---|---|---|---|---|
| Mixed layer | Catalytic component | Type | Fe | — | Fe | Fe |
| (however, regarding | Catalyst carrier | Type | Al₂O₃ | | — | Al₂O₃ |
| Comparative examples | component | | | | | |
| 3 and 6, only the | | | | | | |
| catalytic component) | | | | | | |

| | | | | | |
|---|---|---|---|---|---|
| Evaluation item | CNT coating area | C | C | B | C |
| (Success or failure of CNT | CNT length | B | C | C | B |
| synthesis) | | | | | |

| | | | | Comparative | Comparative | Comparative |
|---|---|---|---|---|---|---|
| | | | | Example 5 | Example 6 | Example 7 |
| Supported | Support body having | Support body | Volume average particle | 0.3 | 0.3 | — |
| catalyst | catalytic layer on | (alumina beads) | diameter [mm] | | | |
| | surface | Support body | Volume average particle | — | — | 0.2 |
| | (however, regarding | (zirconia beads) | diameter [mm] | | | |
| | Comparative examples | Catalytic layer (Fe) | Number of layers | 1 | 1 | — |

| 1,4 and 7, only the | | Number of rounds of CNT synthesis [No.] | | 1 | 1 | |
|---|---|---|---|---|---|---|
| support body) | | | | | | |
| Contract | Mixed | Catalyst raw material | Type | — | Iron (II) | Iron (II) |
| treatment | solution | | | | acetate | acetate |
| | | | Concentration [10⁻³ mol/L] | | 30 | 30 |
| | | | Supersaturation ratio [—] | | 0.75-1.0 | 0.75-1.0 |
| | | Catalyst carrier raw | Type | | — | AliP |
| | | material | Concentration [10⁻³ mol/L] | | | 36 |
| | | | Supersaturation ratio [—] | | | 0.50 |

| | | |
|---|---|---|
| Concentration ratio of catalyst raw material/catalyst | — | 0.83 |
| carrier raw material (Fe/Al) [—] | | |
| Absolute value of differnce of supersaturation ratios | — | 0.25-0.5 |
| (\|catalyst raw material − catalyst carrier | | |
| raw materia\|) [—] | | |

| | | |
|---|---|---|
| Number of rounds of treatment [No.] | 1 | 1 |

| | | | | | |
|---|---|---|---|---|---|
| Mixed layer | Catalytic component | Type | — | Fe | Fe |
| (however, regarding | Catalyst carrier | Type | | — | Al₂O₃ |
| Comparative examples | component | | | | |
| 3 and 6, only the | | | | | |
| catalytic component) | | | | | |

| | | | | |
|---|---|---|---|---|
| Evaluation item | CNT coating area | C | Evaluation | B |
| (Success or failure of CNT | CNT length | C | impossible | A |
| synthesis) | | | due to | |
| | | | synthesis | |
| | | | instability | |

It is understood from Table 1 that in the supported catalyst of Examples 1 to 4 which brought the mixed solution comprising the catalyst raw material and the catalyst carrier raw material into contact with the support body having the catalytic layer on the surface to form the predetermined mixed layer, the evaluation results of the CNT coating area was good, and high quality CNTs can be efficiently and repeatedly prepared. On the one hand, in the supported catalysts of Comparative Examples 2, 3, 5 and 6 in which the predetermined mixed layer was not formed, the evaluation results of the CNT coating area were inferior to Examples 1 to 4 (4-1 and 4-2), and high-quality CNTs could not be stably synthesized. Further, even in Comparative Examples 1, 4, and 7 in which the predetermined mixed layer was formed on the support body which does not have a catalytic layer on the surface, high-quality CNTs could not be synthesized.

### INDUSTRIAL APPLICABILITY

The present disclosure provides a manufacturing method for a supported catalyst which can manufacture a supported catalyst which can efficiently and repeatedly prepare high-quality carbon nanostructures.

Further, the present disclosure can provide a method of manufacturing the carbon nanostructures which can efficiently and repeatedly manufacture high-quality carbon nanostructures.

1. A manufacturing method for supported catalysts, comprising a step A of forming a mixed layer having a catalyst component and a catalyst carrier component on at least a portion of the surface of a support body having a catalytic layer by bringing a mixed solution comprising a catalyst raw material and a catalyst carrier raw material into contact with the support body having a catalytic layer on the surface.

2. The manufacturing method for supported catalysts according to claim 1 further comprising a step B in which the catalyst component is made to segregate to a surface portion of the mixed layer after the step A.

3. The manufacturing method for supported catalysts according to claim 2, wherein a reducing agent is applied to the mixed layer in the step B.

4. The manufacturing method for supported catalysts according to claim 1, wherein the absolute value of the difference between a supersaturation ratio of the catalyst raw material and a supersaturation ratio of the catalyst carrier raw material in the mixed solution is 0.5 or less.

5. The manufacturing method for supported catalysts according to claim 4, wherein the supersaturation ratio of the catalyst raw material and/or the supersaturation ratio of the catalyst carrier raw material in the mixed solution is 0.3 or more and 1.0 or less.

6. The manufacturing method for supported catalysts according to claim 1, wherein the support body is ceramic particles.

7. The manufacturing method for supported catalysts according to claim 6, wherein the apparent density of the ceramic particles is 2.0 g/cm3 or more.

8. The manufacturing method for supported catalysts according to claim 1, wherein the catalyst raw material comprises at least one element selected from the group consisting of Fe, Co and Ni.

9. A method of manufacturing carbon nanostructures comprising a step C which uses the supported catalyst obtained by the manufacturing method according to claim 1 to synthesize the carbon nanostructures.

10. The method of manufacturing the carbon nanostructures according to claim 9, wherein the carbon nanostructures are carbon nanotubes.
